(19) United States
(12) Patent Application Publication
(10) Pub. No.: US 2013/0154172 A1
(43) Pub. Date: Jun. 20, 2013

(54) Rigidity-Controllable Device and Damping-Controllable Shock-Absorbing Apparatus Comprising the Same

(71) Applicant: NATIONAL TSING HUA UNIVERSITY, Hsinchu (TW)

(72) Inventors: Wen-Kuang HSU, Hsinchu (TW); Ming-Hsiao WENG, Hsinchu (TW)

(73) Assignee: NATIONAL TSING HUA UNIVERSITY, Hsinchu (TW)

(21) Appl. No.: 13/707,257

(22) Filed: Dec. 6, 2012

(30) Foreign Application Priority Data
Dec. 19, 2011 (TW) 100147109

(51) Int. Cl. F16F 7/00

(52) U.S. Cl. CPC F16F 7/00; Y10S 977/902; B82Y 30/00
USPC 267/141; 977/902

(57) ABSTRACT

A rigidity-controllable device and a damping-controllable shock-absorbing apparatus comprising the same are disclosed. The rigidity-controllable device of the present invention comprises: a composite comprising a polymer base and a nano-conductive material dispersed in the polymer base; and a power supply electrically connecting with the composite; wherein when the power supply electricity to the composite, temperature of the composite is increased and thus the rigidity of the composite is adjusted.

### CROSS REFERENCE TO RELATED APPLICATION

This application claims the benefits of the Taiwan Patent Application Serial Number 100147109, filed on Dec. 19, 2011, the subject matter of which is incorporated herein by reference.

### BACKGROUND OF THE INVENTION

1. Field of the Invention

The present invention relates to a rigidity-controllable device and, more particularly to a rigidity-controllable device that the rigidity of a composite thereof is adjusted by electricity.

2. Description of Related Art

In the condition without any external force (for example, outer space), the shocks caused by the working of aircrafts such as artificial satellites and photovoltaic devices can only be eliminated by the materials contained therein, and there are no other external material can provide damping effect to the aircrafts to reduce these shocks. Hence, a material, which has better stability and is capable of enduring a level of vibration, has to be provided for the artificial satellite and the photovoltaic devices.

Not only the aircrafts, big bridge piers and building may vibrate due to external force such as winds and waves with resonance frequencies. When large amplitude vibrations are occurred on the building or the bridge piers torqued or vibration times are too long, the material of the building or the bridge piers may be damages. For example, the Tacoma Narrows Bridge was broken due to this reason.

In order to solve the aforementioned problem, a shock-absorbing device such as a damper is developed to provide an anti-force to reduce the vibration caused by the external force. The shock-absorbing device is generally used in aircrafts, military fields, firearms and motor vehicles. For the artificial satellite, the shock-absorbing effect is conventionally accomplished by a hydraulic damper, which can exhaust the vibration caused by external force through the resistance force generated by regulating devices. However, the conventional hydraulic damper is big and the manufacture cost thereof is high.

Thermosetting polymer, which does not have fluidity and has larger strength, is a material that the damping factor thereof can be interchanged between high damping factor and low damping factor. When the thermosetting polymer is heated, the molecule activity thereof is increased, and therefore the damping factor thereof can be changed from low damping factor to high damping factor. When the thermosetting polymer is cooled, the damping factor can be recovered to low damping factor. The thermosetting polymer is a non-conductive material, so an external heating source such as hot plate has to be provided on the surface of the thermosetting polymer to increase the damping factor thereof. However, the heating source can only applied on the surface thereof, so the whole polymer cannot be heated uniformly. The un-uniform heating may cause the damping factor on the surface of the thermosetting polymer is different to that inside the thermosetting polymer. In addition, low heating rate also causes the thermosetting polymer cannot be applied to various fields.

Hence, it is desirable to provide a damping factor-controllable device, wherein the damping factor thereof can be interchanged between high damping factor and low damping factor rapidly.

### SUMMARY OF THE INVENTION

The present invention provides a rigidity-controllable and damping factor-controllable device, which comprises: a composite comprising a polymer base, and a nano-conductive material dispersed in the polymer base; and a power supply electrically connecting with the composite, and supplying electricity to the composite, wherein when the power supply supplies the electricity to the composite, a temperature of the composite is increased and thus the rigidity of the composite is adjusted.

According to the rigidity-controllable device of the present invention, the composite is a material which is prepared by mixing the nano-conductive material such as carbon nanotubes with the polymer base. It is known that the polymer base is a non-conductive material and cannot be heated by ohmic heating. However, since the non-conductive material is dispersed in the polymer base to form the composite of the preset invention, the electricity can be introduced into the nano-conductive material to rise the temperature of the composite of the polymer base through ohmic heating. In addition, the nano-conductive material are uniformly dispersed in the polymer base, so the whole composite can be heated and the problem that only a single surface, an outer surface or a local portion is heated can be eliminated. Furthermore, the inventors also confirmed that the rigidity change in the composite of the present invention has homogeneity and reversibility.

It should be noted that the nano-conductive material such as carbon nanotubes applied in the present invention is used to provide conductivity to the composite, and not used to adjust the rigidity of the polymer base. In the present invention, the rigidity of the composite can be adjusted through the temperature change when the composite is heated by ohmic heating. More specifically, the nano-conductive material dispersed in the polymer base of the present invention can make the property of the composite interchange between a rigid material and a shock-absorbing material. Although an example of the nona-conductive material in the present invention is carbon nanotubes, the present invention is not limited thereto.

In the rigidity-controllable device of the present invention, the property of the composite can be adjusted between high rigidity and low rigidity. When the composite has high rigidity, it has high damping factor and can be used to absorb shock. When the composite has low rigidity, it has low damping factor and can be used as a supporting material. Hence, the rigidity-controllable device of the present can be applied to various fields, such as a bridge pier, a building, an artificial satellite, a photovoltaic device, a transporting device, an aircraft, or a portable electronic device. When the rigidity-controllable device is applied to the aircraft, the device can be mounted on wings or landing gears of an airplane to provide a shock-absorbing effect and therefore a safe and suitable environment can be provided to passengers during flying. When the rigidity-controllable device is applied to the portable electronic device such as camera, it can prevent lens shift due to the camera shake.

In the rigidity-controllable device of the present invention, a predetermined temperature of the composite can be reached rapidly by providing electricity. For example, when the power of the electricity supplied by the power supply is 5.82 J/s and the resistance thereof is 1100Ω, the temperature of the composite can be increased to 80° C. during 20 sec.

In the rigidity-controllable device of the present invention, the material of the polymer base can be any thermosetting polymer base. A preferred example of the polymer base can be resin, rubber or silicone.

In the rigidity-controllable device of the present invention, the power of the electricity supplied by the power supply preferably is 1.5 J/s-6 J/s. Since the supplied voltage or current is related to resistance, it is more preferable to recite the electricity by its power. If the power of the electricity is too big, the high temperature of the carbon nanotubes may lead the polymer base degraded.

In the rigidity-controllable device of the present invention, the nano-conductive material can be carbon nanotubes, nano-conductive wires, or the like. Preferably, the nano-conductive material is carbon nanotubes.

In the rigidity-controllable device of the present invention, a content of the nano-conductive material in the composite can be 0.4 wt %-10 wt % such as 1 wt %, 2 wt % or 4 wt %, based on a total weight of the composite. When the content of the nano-conductive material in the composite is more than 10 wt %, the excess nano-conductive material cannot provide more contribution to the rigidity change and the conductivity of the composite. On the contrary, the increased content of the nano-conductive material may cause the viscosity of the mixture of the nano-conductive material and the polymer base too high. The high viscosity of the mixture may cause difficulties in the dispersion of nano-conductive material and the manufacturing process, and therefore the manufacture cost may be increased. Hence, the content of the nano-conductive material in the composite preferably is 0.5 wt %-10 wt %. More preferably, the content is 1 wt %-4 wt %.

In the rigidity-controllable device of the present invention, preferably, the nano-conductive material has conductivity (σ) of 0.5×10⁻¹ S/m-8×10⁻¹ S/m. More preferably, the conductivity of the nano-conductive material is 2.08×10⁻¹ S/m-8×10⁻¹ S/m. In the present invention, the required power can be reduced when the conductivity of the nano-conductive material is high.

In the rigidity-controllable device of the present invention, after the power supply supplied the electricity to the composite, the temperature of the composite is increased to a temperature between an ambient temperature such as room temperature to a glass transition temperature of the polymer base. For example, when epoxy resin is used as the polymer base, the temperature of the composite is preferably 25° C.-90° C., more preferably 25° C.-80° C. Under this temperature range, the rebound ratio of the composite is decreased as the temperature thereof is increased. More specifically, when the epoxy resin is used as the polymer base, the rebound ratio of the composite is decreased as the temperature thereof is increased, under the temperature range of 25° C.-80° C. For example, when the temperature of the composite is 25° C., the rebound ratio thereof is about 69%. When the temperature of the composite is 80° C., the rebound ratio thereof is about 9%.

In the rigidity-controllable device of the present invention, the rebound ratio of the composite is 10%-90%, preferably. The rebound ratio is related to the properties of the polymer base, and the kinds and the contents of the nano-conductive material.

In the rigidity-controllable device of the present invention, a hardness of the composite is adjusted from 30 to 80, which is measured by TECLOCK rubber hardness tester, Teclock GS-720G, type D.

In the rigidity-controllable device of the present invention, preferably, the temperature of the composite is adjusted through Ohmic heating.

In the rigidity-controllable device of the present invention, preferably, the composite has a cube shape, a sphere shape, an ellipsoid shape, a plate shape, a trapezoid shape, an L-shape, an M shape, a disc shape or an irregular shape. The shape of the composite can be adjusted according to the applied device, so the rigidity-controllable device of the present invention can be applied to various fields.

The present invention further provides a damping-controllable shock-absorbing apparatus, which comprises a rigidity-controllable device.

Preferably, the damping-controllable shock-absorbing apparatus of the present invention can be applied to a bridge pier, a building, an artificial satellite, a photovoltaic device, a transporting device, an aircraft, or a portable electronic device.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a rigidity-controllable device according to Embodiment 3 of the present invention;

FIG. 2A is a perspective view of a conventional bridge pier that there is no shake-absorbing unit mounted thereon;

FIG. 2B is a perspective view of a bridge pier that a rigidity-controllable device is mounted thereon according to Embodiment 4 of the present invention;

FIG. 3A shows rebounding test results on specimens of Embodiments 1-2 and Comparative Embodiment of the present invention;

FIG. 3B shows rebounding test results on specimens of Embodiment 2 of the present invention at different temperatures;

FIG. 4A and FIG. 4B show the hardness and Young's modulus of specimens of Embodiment 2 of the present invention;

FIG. 5 shows a testing result on a rigidity-controllable device of Embodiment 3 of the present invention under different voltages at different times and temperatures; and

FIG. 6 shows a testing result that a required time for heating the composite of Embodiment 3 of the present invention under different voltages.

### DETAILED DESCRIPTION OF THE PREFERRED EMBODIMENT

### Embodiments 1-2 and Comparative Embodiment

To a mixture package, multi-wall nanotubes (MWNT) (i.e. carbon nanotubes) and epoxy resin part A (E-132 (A), available from FONG YONG Chemicla Co., Ltd.) with a predetermined ratio (as shown in Table 1) were added. The package was sealed with a seal clip, and the resulting mixture was dispersed by hand for 30 min. Then, epoxy resin part B (H-TK(B), available from FONG YONG Chemicla Co., Ltd.) was added into the mixture, and the resulting mixture was further dispersed by hand for 10 min. In the present embodiments, the weight ratio of epoxy resin part A to epoxy resin part B is 2:1.

Next, bubbles in the mixture were removed in vacuo for 10 min.

The mixture package was cut to form a small hole, and the resulting mixture therein was poured into a space between two aluminum sheets via this small hole. Bubbles were continuously removed in vacuo until the mixture was solidified.

The solidified mixture was placed at 60° C. overnight, and then at 90° C. for 3 hr. Finally, a specimen with a size of 15 mm×15 mm×3 mm was obtained.

TABLE 1

| | Content of MWNT | Conductivity (σ) |
|---|---|---|
| Embodiment 1 | 2 wt % | 2.08 × 10⁻¹ S/m |
| Embodiment 2 | 4 wt % | 3.03 × 10⁻¹ S/m |
| Comparative Embodiment | 0 | (No conductivity) |

### Embodiment 3

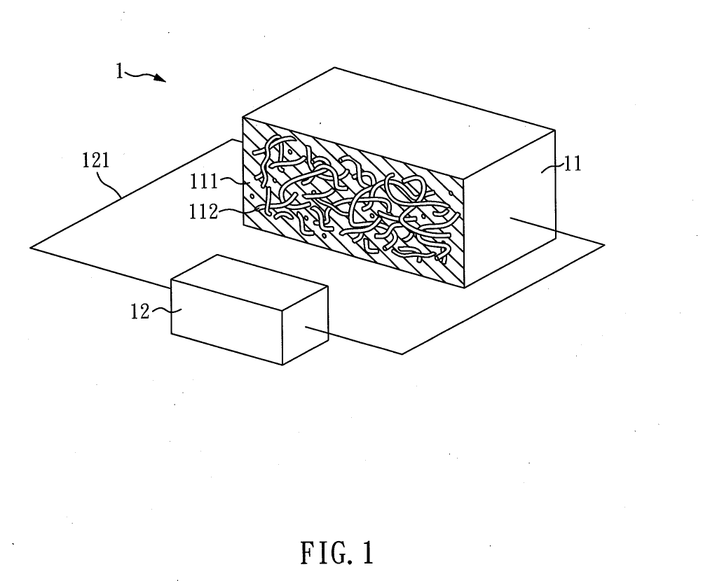

As shown in FIG. 1, the composite 11 (i.e. specimen) of Embodiment 2 was electrically connected to a power supply 12 to obtain a rigidity-controllable device 1 of the present embodiment.

The rigidity-controllable device 1 of the present embodiment comprises: a composite 11 comprising a polymer base 111, and a nano-conductive material 112 dispersed in the polymer base 111; and a power supply 12 electrically connecting with the composite 11 through an electric wire 121, and supplying electricity to the composite 11, wherein when the power supply 12 supplies the electricity to the composite 11, a temperature of the composite 11 is increased and thus the rigidity of the composite 11 is changed.

In the present embodiment, the material of the polymer base 111 is epoxy resin, and the nano-conductive material 112 is carbon nanotubes such as MWNT.

However, the nano-conductive material 112 is not limited to carbon nanotubes, and can also be other conductive materials such as nano-conductive wires, particles or silk thread. Preferably, the nano-conductive material 112 is carbon nanotubes.

Furthermore, the polymer base 111 is not limited to epoxy resin, and can also be other material such as robber, resin or silicone.

In addition, the shape of the composite 11 can be a cube shape, a sphere shape, an ellipsoid shape, a plate shape, a trapezoid shape, an L-shape, an M shape, a disc shape or an irregular shape (not shown in the figure). The shape of the composite 11 can be adjusted according to the applied devices or apparatuses, and is not limited to the cube shape of the present embodiment.

According to the rigid-controllable device of the present embodiment, it is possible to increase the temperature of the composite to a predetermined temperature rapidly. For example, when the power supply provide 80V the composite with a resistance of 1100Ω in which the corresponding power is 5.82 J/s, the temperature of the composite can be increased to 80° C. in 20 sec. The rapid increase of the temperature of the composite cannot be obtained by any conventional device.

The rigidity-controllable device of the present embodiment can also be used as a shock-absorbing apparatus, which can further be applied to various fields such as a bridge pier, a building, an artificial satellite, a photovoltaic device, a transporting device, an aircraft, or a portable electronic device.

### Embodiment 4

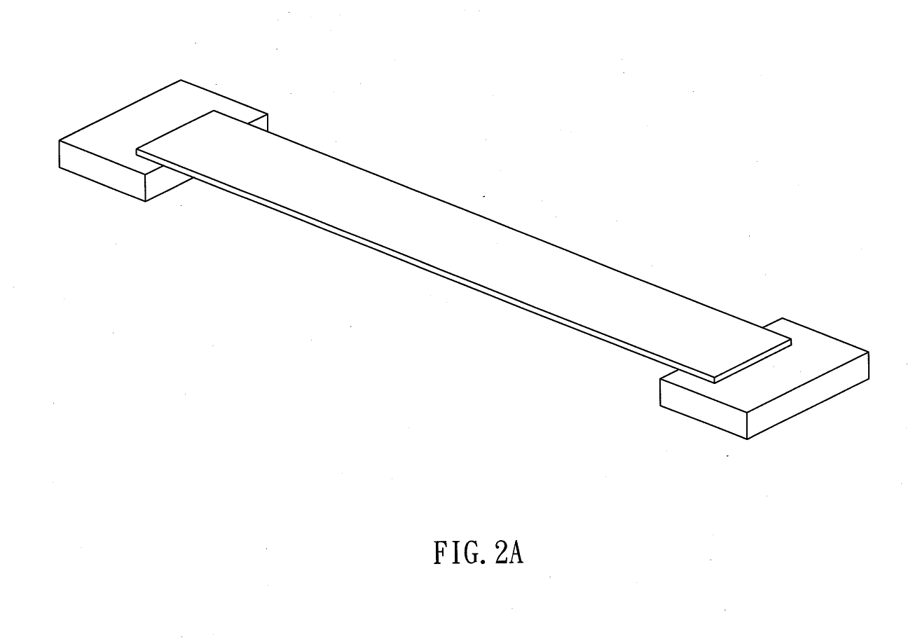

FIG. 2B is a perspective view of a bridge pier that rigidity-controllable device of the present embodiment is mounted thereon, and FIG. 2A is a perspective view of a conventional bridge pier that there is no shake-absorbing unit mounted thereon.

As shown in FIG. 2B, the composite 11 of the present invention is mounted between bridge decks 21 and is fixed with screws 22. The rigidity and the damping factor of the composite 11 is controlled through a power supply (not shown in the figure) to show a shock-absorbing effect on the bridge pier.

In the rigidity-controllable device of the present invention, the rigidity and the damping factor of the composite can be adjusted. When the composite has high rigidity, it has high damping factor and can be used to absorb shock. When the composite has low rigidity, it has low damping factor and can be used as a supporting material. Hence, the rigidity-controllable device of the present can be applied to various fields, such as a bridge pier, a building, an artificial satellite, a photovoltaic device, a transporting device, an aircraft, or a portable electronic device.

### [Rebounding Test]

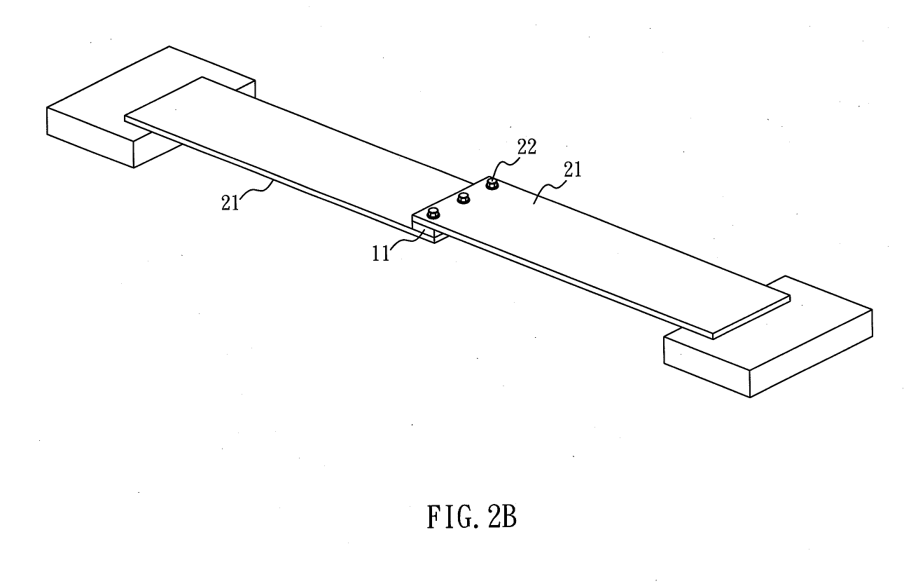

The specimens of Embodiments 1-2 and Comparative Embodiment were heated by a hot plate, and the rebound ratio thereof were measured with Ball Rebound at different temperature points (30° C. to 90° C., measured in each 5° C.). The rebounding test results shown in FIG. 3A indicates that the rigidity of all the specimens of Embodiments 1-2 and Comparative Embodiment can be changed by simply heating.

In addition, the specimen of Embodiment 2 was also heated by Ohmic heating and a hot plate, and the rebound ratio thereof were measured with Ball Rebound at different temperature points (30° C. to 90° C., measured in each 5° C.). The rebounding test results shown in FIG. 3B indicate the rigidity and the damping factor can be changed by both Ohmic heating and the hot plate.

### [Hardness and Young's Modulus Tests]

The hardness and Young's modulus tests were performed on the specimen of Embodiment 2. The hardness of the specimen was measured by TECLOCK rubber hardness tester, Teclock GS-720G, type D, and the Young's modulus of the specimen was measured by Laser Doppler Velocimetry. Young's modulus is one factor reciting the ability of anti-deformation of solid material.

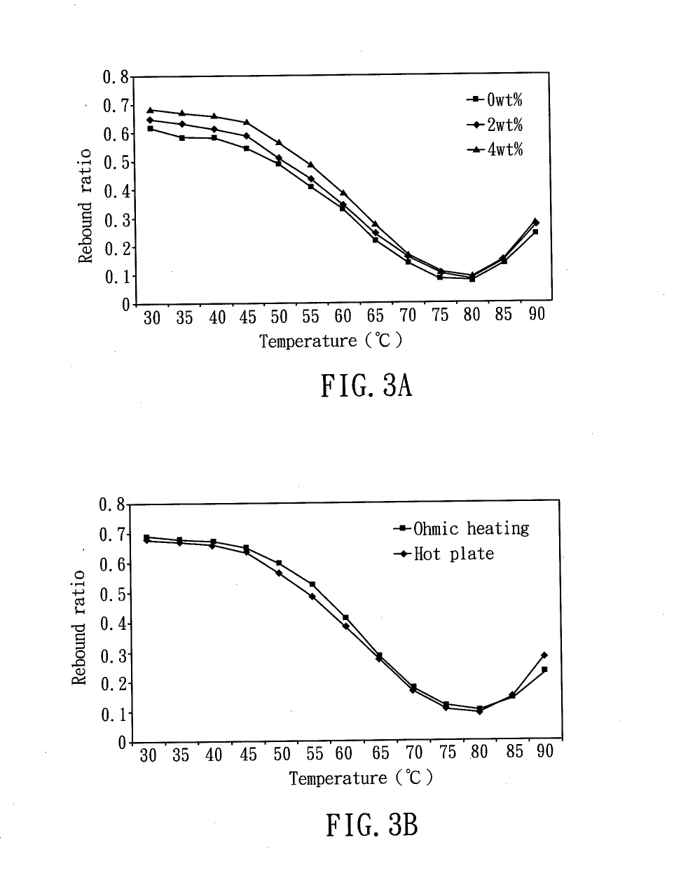

FIG. 4A and FIG. 4B show the hardness and Young's modulus of specimens of Embodiment 2 of the present invention. These results indicate that the decreased rounding ratio of the specimen by heating is not caused by the increase of the hardness thereof, but is caused by the increase of the elasticity thereof. Herein, there are no data about the Young's modulus thereof at 80° C. and 90° C., and it is because that the increased elasticity can absorb external shock. Since the external shock was absorbed by the specimen, the Young's modulus cannot be detected.

### [Heating Effect by Different Voltage]

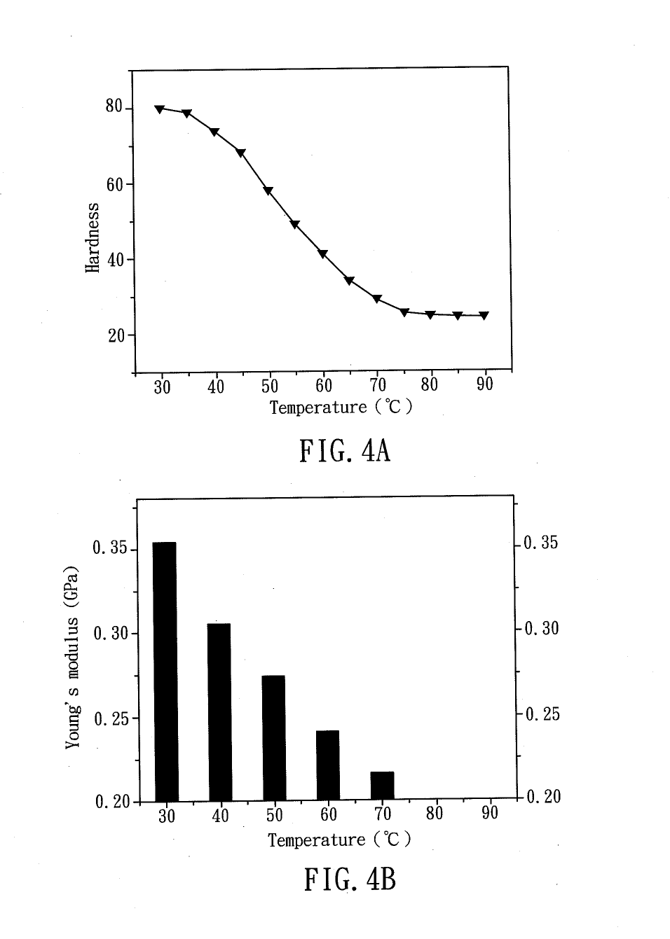

Different voltages were applied on the composite 11 of the rigidity-controllable device 1 of Embodiment 3, wherein the resistance of the composite 11 is 1100Ω The temperature change related to the time is shown in FIG. 5.

As shown in FIG. 5, the temperature increased faster as the applied voltage increased, and the final balance temperature was also increased. Hence, the increase of the temperature of the composite 11 can be adjusted with different applied voltages.

### [Test on Increasing Rate of Temperature]

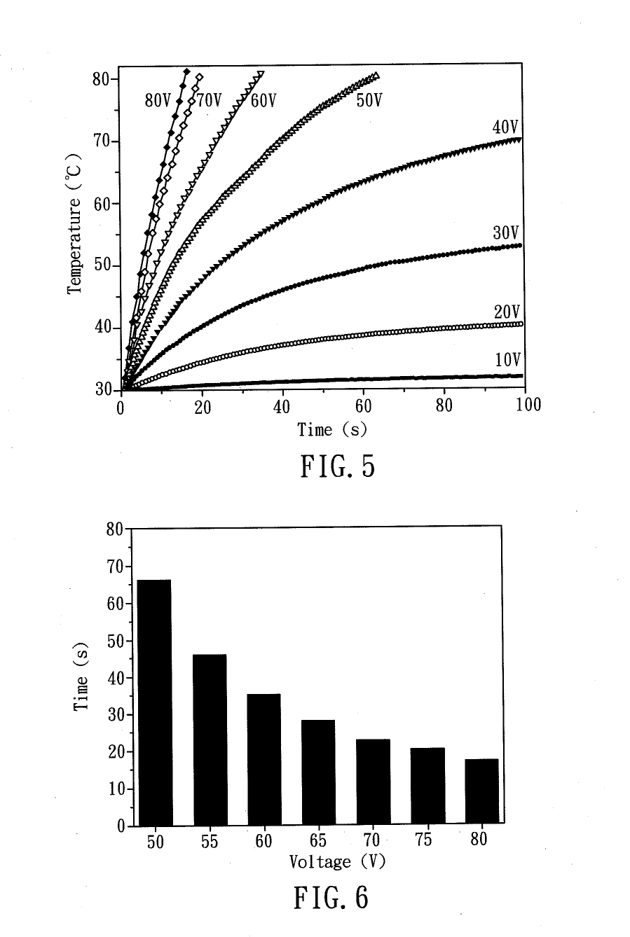

Different voltages were applied to composite 11 of the rigidity-controllable device 1 of Embodiment 3, wherein the resistance of the composite 11 is 1100Ω. The times required for increasing the temperature of the composite to 80° C. were measured, and the result is shown in FIG. 6.

As shown in FIG. 6, the temperature increased faster as the applied voltage increased. When 80V was applied to the composite, the temperature of the composite can be increased to 80° C. in 20 sec. This result indicates that the property of the rigidity-controllable device can be adjusted between high rigidity/damping factor and low rigidity/damping factor rapidly.

In conclusion, nano-conductive material such as carbon nanotubes is mixed into the polymer base to form the composite of the present invention. It is known that the polymer base is a non-conductive material and cannot be heated by ohmic heating. However, since the non-conductive material is dispersed in the polymer base to form the composite of the preset invention, the electricity can be introduced into the nano-conductive material to rise the temperature of the composite of the polymer base through ohmic heating. In addition, the nano-conductive material are uniformly dispersed in the polymer base, so the whole composite can be heated uniformly and the problem that only a single surface, an outer surface or a local portion is heated can be eliminated. Furthermore, the aforementioned experimental data also indicate that the rigidity change in the composite of the present invention has homogeneity and reversibility.

It should be noted that the nano-conductive material such as carbon nanotubes applied in the present invention is used to provide conductivity to the composite, and not used to adjust the rigidity of the polymer base. In the present invention, the rigidity of the composite can be adjusted through the temperature change when the composite is heated by ohmic heating. More specifically, the nano-conductive material dispersed in the polymer base of the present invention can make the property of the composite interchange between a rigid material and a shock-absorbing material. Although an example of the nona-conductive material in the present invention is carbon nanotubes, the present invention is not limited thereto.

Hence, the rigidity-controllable device of the present can be applied to various fields, such as a bridge pier, a building, an artificial satellite, a photovoltaic device, a transporting device, an aircraft, or a portable electronic device. When the rigidity-controllable device is applied to the aircraft, the device can be mounted on wings or landing gears of an airplane to provide a shock-absorbing effect and therefore a safe and suitable environment can be provided to passengers during flying. When the rigidity-controllable device is applied to the portable electronic device such as camera, it can prevent lens shift due to the camera shake.

Although the present invention has been explained in relation to its preferred embodiment, it is to be understood that many other possible modifications and variations can be made without departing from the spirit and scope of the invention as hereinafter claimed.

What is claimed is:

1. A rigidity-controllable device, comprising:
a composite comprising a polymer base, and a nano-conductive material dispersed in the polymer base; and
a power supply electrically connecting with the composite, and supplying electricity to the composite,
wherein when the power supply supplies the electricity to the composite, a temperature of the composite is increased and thus the rigidity of the composite is adjusted.

2. The rigidity-controllable device as claimed in claim 1, wherein the polymer base is a thermosetting polymer base.

3. The rigidity-controllable device as claimed in claim 1, wherein the thermosetting polymer base is made of resin, rubber or silicone.

4. The rigidity-controllable device as claimed in claim 1, wherein a power of the electricity supplied by the power supply is 1.5 J/s-6 J/s.

5. The rigidity-controllable device as claimed in claim 1, wherein the nano-conductive material is carbon nanotubes.

6. The rigidity-controllable device as claimed in claim 1, wherein a content of the nano-conductive material in the composite is 0.4 wt %-10 wt %, based on a total weight of the composite.

7. The rigidity-controllable device as claimed in claim 1, wherein the nano-conductive material has conductivity (σ) of 0.5×10⁻¹ S/m-8×10⁻¹ S/m.

8. The rigidity-controllable device as claimed in claim 1, wherein when the power supply supplied the electricity to the composite, the temperature of the composite is increased to a temperature between an ambient temperature to a glass transition temperature of the polymer base.

9. The rigidity-controllable device as claimed in claim 8, wherein when the power supply supplied the electricity to the composite, the temperature of the composite is in a range from 25° C. to 90° C.

10. The rigidity-controllable device as claimed in claim 1, wherein a rebound ratio of the composite is 10%-90%.

11. The rigidity-controllable device as claimed in claim 1, wherein a hardness of the composite is adjusted from 30 to 80.

12. The rigidity-controllable device as claimed in claim 1, wherein the temperature of the composite is adjusted through Ohmic heating.

13. The rigidity-controllable device as claimed in claim 1, wherein the composite has a cube shape, a sphere shape, an ellipsoid shape, a plate shape, a trapezoid shape, an L-shape, an M shape, a disc shape or an irregular shape.

14. A damping-controllable shock-absorbing apparatus, comprising a rigidity-controllable device as claimed in any of claims 1 to 12.

15. The damping-controllable shock-absorbing apparatus, which is applied to a bridge pier, a building, an artificial satellite, a photovoltaic device, a transporting device, an aircraft, or a portable electronic device.
